(19) United States
(12) Patent Application Publication
(10) Pub. No.: US 2025/0010744 A1
(43) Pub. Date: Jan. 9, 2025

(54) MODULAR HIGH POWER ELECTRIC VEHICLE CHARGING SKID

(71) Applicant: Faith Technologies, Inc., Menasha, WI (US)

(72) Inventors: Joseph Michael Loose, Menasha, WI (US); Austin M. MacDonald, Shawnee, KS (US); Robert S. Messina, Oshkosh, WI (US)

(21) Appl. No.: 18/762,866

(22) Filed: Jul. 3, 2024

Related U.S. Application Data
(60) Provisional application No. 63/525,467, filed on Jul. 7, 2023.

(51) Int. Cl. B60L 53/31

(52) U.S. Cl. CPC B60L 53/31; B60L 2210/30

(57) ABSTRACT

An electric vehicle (EV) charging skid including at least one EV charger includes a pre-cast concrete skid base having an aperture formed therethrough; a power cabinet connected to the skid base such that the power cabinet covers the aperture, wherein the power cabinet is configured to receive electricity from an electrical source via the aperture; a panel cabinet connected to the skid base, wherein the panel cabinet is in electrical communication with the power cabinet; a first power converter unit connected to the skid base, wherein the first power converter unit is in electrical communication with the panel cabinet; and an EV charger connected to the skid base separately from the first power converter unit, wherein the EV charger is in electrical communication with the first power converter unit.

The present application claims priority to the earlier-filed US Provisional Patent Application having Ser. No. 63/525,467, and hereby incorporates the subject matter of the provisional application in its entirety.

### BACKGROUND OF THE INVENTION

Siting of a ground mount electric vehicle (EV) charger typically requires leveling a spot, installing forms, rebar, and conduits, and then pouring concrete to create the slab on which a charger is positioned. This process is expensive, overly permanent, and requires significant worker hours from multiple trades. In addition, adverse weather and other environmental conditions can complicate the installation work because all of the work is done on site and typically outdoors.

### SUMMARY OF THE INVENTION

The present disclosure solves these issues by providing an easy-to-install pick-and-place EV charging skid that can be manufactured under the controlled conditions of a factory and installed with minimal field work. A cable raceway system allows the EV charging skid to accommodate most charger designs and desired orientations without requiring a custom installation on site. The EV charging skid can be shipped fully assembled or in a minimal number of sub-assemblies easily assembled on site. The EV charging skid of the present disclosure minimizes the amount of work hours and trades needed at the site; safety, efficiency, and economy are significantly improved.

The present disclosure describes an electric vehicle (EV) charging skid including at least one EV charger, the EV charging skid including a pre-cast concrete skid base having an aperture formed therethrough; a power cabinet having a bottom surface with a cabinet bottom opening, wherein the power cabinet is connected to the skid base such that the power cabinet covers the aperture and the aperture is accessible through the cabinet bottom opening, and wherein the power cabinet is configured to receive electricity from an electrical source via the aperture and cabinet bottom opening; and a panel cabinet connected to the skid base, wherein the panel cabinet is in electrical communication with the power cabinet. The EV charging skid also includes a first power converter unit connected to the skid base, wherein the first power converter unit is in electrical communication with the panel cabinet; and an EV charger connected to the skid base separately from the first power converter unit, wherein the EV charger is in electrical communication with the first power converter unit.

The present disclosure also describes a modular electric vehicle (EV) charging system having at least two EV chargers, the modular EV charging system including a foundational EV charging skid including a pre-cast concrete skid base having an aperture formed therethrough, the pre-cast concrete skid base including transport channels; a panel cabinet having a bottom surface with a cabinet bottom opening, wherein the panel cabinet is connected to the pre-cast concrete skid base such that the panel cabinet covers the aperture and the aperture is accessible through the cabinet bottom opening, and wherein the panel cabinet is configured to receive electricity from an electrical source via the aperture and cabinet bottom opening. The modular EV charging system also includes a first power converter unit connected to the pre-cast concrete skid base, wherein the first power converter unit is in electrical communication with the panel cabinet; a second power converter unit connected to the pre-cast concrete skid base separately from the first power converter unit, wherein the second power converter unit is in electrical communication with the panel cabinet; and a first EV charger connected to the pre-cast concrete skid base separately from the first and second power converter units, wherein the first EV charger is in electrical communication with the first and second power converter units. The modular EV charging system also includes third and fourth power converter units connected to the pre-cast concrete skid base separately from each other and from the first and second power converter units, wherein the third and fourth converter units are in electrical communication with the panel cabinet; a second EV charger connected to the pre-cast concrete skid base separately from the third and fourth power converter units, wherein the second EV charger is in electrical communication with the third and fourth power converter units; and a cable raceway connected to the pre-cast concrete skid base and connecting the panel cabinet to the first, second, third, and fourth power converter units, the first and second converter units to the first EV charger, and the third and fourth power converter units to the second EV charger.

The present disclosure alternatively describes a method for providing at a site an electric vehicle (EV) charging system including an EV charging skid, the method including procuring a pre-cast concrete skid base having an aperture formed therethrough; affixing to the pre-cast concrete skid base a panel cabinet having a bottom surface with a cabinet bottom opening such that the panel cabinet covers the aperture and the aperture is accessible through the cabinet bottom opening, wherein the panel cabinet is configured to receive electricity from an electrical source via the aperture and cabinet bottom opening; affixing a first power converter unit to the pre-cast concrete skid base, wherein the first power converter unit is in electrical communication with the panel cabinet; affixing an EV charger to the pre-cast concrete skid base separately from the first power converter unit, wherein the EV charger is in electrical communication with the first power converter unit; and then delivering the EV charging skid to the site.

### BRIEF DESCRIPTION OF DRAWINGS

The foregoing and other features and aspects of the present disclosure and the manner of attaining them will become more apparent, and the disclosure itself will be better understood by reference to the following description, appended claims and accompanying drawings, where:

FIG. 1 representatively illustrates a perspective view of an EV charging skid of the present disclosure with generic EV chargers;

FIG. 2 representatively illustrates a plan view of the EV charging skid of FIG. 1;

FIG. 3 representatively illustrates a plan view of an EV charging extension skid as an addition to the EV charging skid of FIGS. 1 and 2;

FIG. 4 representatively illustrates a plan view of a battery energy storage system extension skid as an addition to the EV charging skid of FIGS. 1 and 2;

FIG. 5 representatively illustrates a plan view of a remote EV charging skid with battery energy storage system as an addition to the EV charging skid of FIGS. 1 and 2;

FIG. 6 representatively illustrates a plan view of an alternative remote EV charging skid as an addition to the EV charging skid of FIGS. 1 and 2; and

FIG. 7 representatively illustrates a plan view of an alternative supplemental EV charging skid as an addition to the EV charging skid of FIGS. 1 and 2.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION OF THE INVENTION

Reference now will be made in detail to various aspects of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one aspect, can be used on another aspect to yield a still further aspect. Thus, it is intended that the present disclosure covers such modifications and variations as come within the scope of the appended claims and their equivalents. Further, for reasons of clarity, repeated identical elements in the figures are not all identified with an element number. As a result, the presence or absence of an element number should not be taken as limiting the disclosure.

As used herein, the term “affixed” means one component or structure is attached or otherwise placed on and bonded to another component or structure in a permanent or semi-permanent manner.

The term “connected” means two components are attached to another component or structure either directly or through one or more intervening components or structures.

When two components are in “electrical communication” with each other, they are connected by a conductor such that one can transmit electricity or an electrical signal to the other, whether or not there are one or more intervening components or structures.

As used herein, the term “cabinet” is used generically to describe any suitable structure for enclosing, protecting, or accommodating electrical connections, conductors, equipment, or other components. Non-limiting examples include electrical cabinets, electrical panels, breaker panels, electrical boxes, junction boxes, enclosures, wireways, cable trays, cable ladders, cable sleeves, caps, and raceways.

The present disclosure provides an easy-to-install pick-and-place EV charging skid that can be manufactured under the controlled conditions of a factory and installed with minimal field work. A cable raceway system allows the EV charging skid to accommodate most charger designs and desired orientations without requiring a custom installation on site. The EV charging skid can be shipped fully assembled or in a minimal number of sub-assemblies easily assembled on site. The EV charging skid of the present disclosure minimizes the amount of work hours and trades needed at the site; safety, efficiency, and economy are significantly improved.

The EV charging system includes a foundational EV charging skid to provide EV charging needs as well as extension, remote, and supplemental EV charging skids where additional charging points, capacity, and storage are desired.

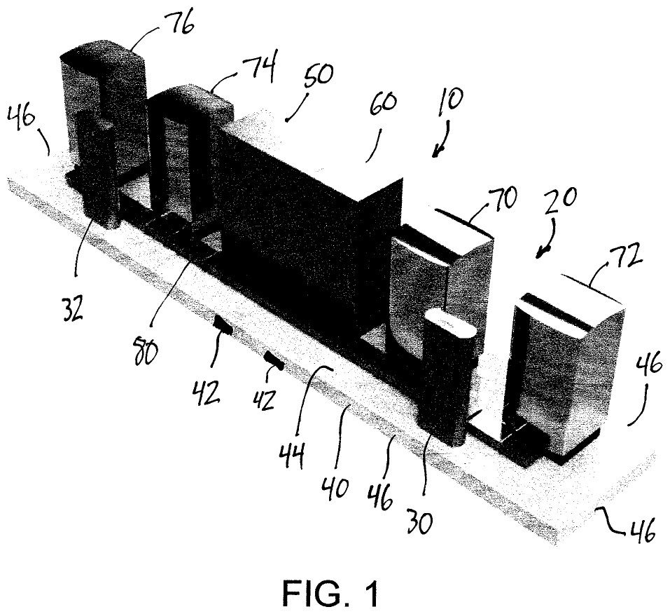

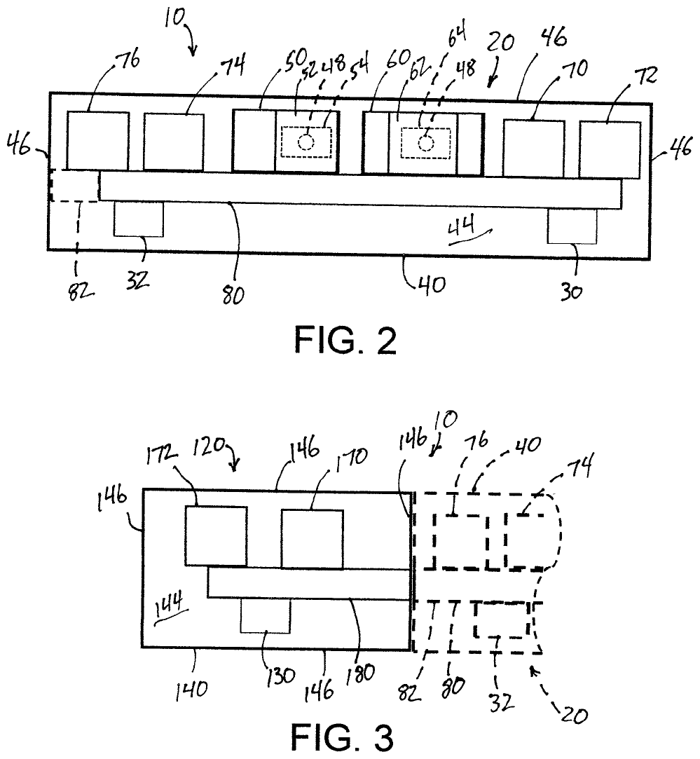

As illustrated in FIGS. 1 and 2, a modular EV charging system 10 of the present disclosure includes an EV charging skid 20 configured to be installed at a site. The EV charging skid 20 is also configured to accommodate one or more EV chargers 30 affixed or connected thereto, shown as a generic representation in FIG. 1. The EV charging skid 20 includes as primary components a skid base 40, an EV charger 30, a power cabinet 50, a panel cabinet 60, a power converter unit 70, a cable raceway 80, and any needed ancillary electrical hardware (not shown).

The skid base 40 of the EV charging skid 20 is a generally slab-like structure constructed from steel, concrete, pre-cast concrete, or any other suitable material. The skid base 40 includes a top 44 and slab sides 46. The skid base 40 can also include internal or external support framework to strengthen the skid base 40. The skid base 40 can optionally include channels 42, lift rings, or other rigging hardware (not shown) to allow the EV charging skid 20 to be moved by forklift, telehandler, crane, or other suitable device.

Any slab side 46 can be provided with a portion of any suitable interlock system (not shown) useful to affix or connect an additional skid base to the skid base 40 for stability. The interlock system can be, for example, a key and keyway, a mortise and tenon, a French cleat, dowels and bolts, bow tie fasteners, staples, U-bolts, cable and anchors, and variations and combinations thereof. Portions of the interlock system can be vertical, horizontal, or angled as appropriate.

The EV charging skid 20 can be set at or below grade on site. In a particular aspect of the present disclosure, the EV charging skid 20 can be in-set 10 inches, for example, into grade to hold the EV charging skid 20 in place.

In other aspects of the present disclosure, the skid base 40 can optionally include anchoring brackets (not shown) attached to the skid base 40 and used to anchor the skid base 40 to the surface on which it is sited. The anchoring brackets can be external to the skid base 40. In other aspects of the present disclosure (not shown), anchoring brackets can be positioned within or beneath the skid base 40 or anchoring brackets can be absent with the skid base 40 affixed directly to the surface on which it is sited. The surface can be any suitable and reasonably level surface but need not be a concrete slab.

The skid base 40 can have one or more apertures 48 (see FIG. 2) formed therethrough from the top 44 to the bottom of the skid base 40. The apertures 48 are sized and positioned to allow materials such as cables, wires, and/or conduit to pass therethrough in either direction between the surface beneath the skid base 40 and the top 44. The apertures 48 can be circular, rectangular, or any suitable shape.

The EV charging skid 20 also includes a power cabinet 50 affixed or connected to the skid base 40. The power cabinet 50 includes a power cabinet bottom surface 52 with a power cabinet bottom opening 54. The power cabinet 50 is affixed or connected to the skid base 40 such that the power cabinet 50 covers the aperture 48 and such that the aperture 48 is accessible through the power cabinet bottom opening 54. The power cabinet 50 is configured to receive electricity from an electrical source via the aperture 48 and the power cabinet bottom opening 54. Because of the high power demanded by multiple EV chargers 30, 32, particularly direct current (DC) fast chargers, the power cabinet 50 can be sized and has components selected to supply at least 2000 amps, although the power cabinet 50 can be configured to supply any desired voltage and current.

The power cabinet 50 can include utility-facing switchgear in electrical communication with the electrical source. The power cabinet 50 can also include metering, load side lugs, and communication equipment. The power cabinet 50 can be subdivided into sub-cabinets or portions for various desired equipment.

The EV charging skid 20 also includes a panel cabinet 60 affixed or connected to the skid base 40. The panel cabinet 60 includes a panel cabinet bottom surface 62 with a panel cabinet bottom opening 64. The panel cabinet 60 is affixed or connected to the skid base 40 such that the panel cabinet 60 covers the aperture 48 and such that the aperture 48 is accessible through the panel cabinet bottom opening 64. The panel cabinet 60 is configured to receive electricity from the power cabinet 50.

The panel cabinet 60 can include distribution switchgear and line side lugs in electrical communication with the power converter unit 70. The panel cabinet 60 can be subdivided into sub-cabinets or portions for various desired equipment. The panel cabinet 60 can be disposed adjacent to (FIG. 1) or separated from (FIG. 2) the power cabinet 50. The panel cabinet 60 can be in electrical communication with the power cabinet 50 via conduit, the cable raceway 80 described below, or by any suitable means. In another aspect of the present disclosure, the power cabinet 50 and the panel cabinet 60 can be sections within the same physical cabinet.

The utility-facing switchgear is in electrical communication with the distribution switchgear. The panel cabinet 60 supplies alternating current (AC) to the first power converter unit 70.

The panel cabinet 60 can also supply energy via its aperture 48 to site needs such as lighting, security systems, communications systems, signage, and other needs. The panel cabinet 60 can supply energy via the cable raceway 80 to extension skids as described below. The panel cabinet 60 can also supply energy via its aperture 48 and underground conduit systems to remote and supplemental skids as described below.

The EV charging skid 20 further includes a first power converter unit 70 affixed or connected to the skid base 40. The first power converter unit 70 is in electrical communication with the panel cabinet 60. The EV charging skid 20 can also include a second power converter unit 72 affixed or connected to the skid base 40 separately and spaced apart from the first power converter unit 70, where the second power converter unit 72 is in electrical communication with the panel cabinet 60. The EV charging skid 20 can also include third and fourth power converter units 74, 76 affixed or connected to the skid base 40 separately from each other and separately from the first and second power converter units 70, 72. The third and fourth power converter units 74, 76 are each in electrical communication with the panel cabinet 60.

In a particular exemplary aspect of the present disclosure, the power converter units described herein can be EXPP-PB1000-500A-PD-FHWA Power Blocks available from ChargePoint, Inc. of Campbell, California. Each is rated at 500 amps and can accommodate up to five EXPP-PM-40KW-FHWA Power Modules rated at 40 kW each and available from ChargePoint, Inc. of Campbell, California. In other aspects of the present disclosure, any suitable power converter units can be used.

The panel cabinet 60 supplies AC to each power converter unit 70, 72, 74, 76 in a manner that can include independent overcurrent protection devices. Each power converter unit 70, 72, 74, 76 converts AC to DC.

The EV charging skid 20 also includes a first EV charger 30 affixed or connected to the skid base 40 separately from and spaced apart from the first and second power converter units 70, 72. The EV charger 30 is in electrical communication with one or both of the first and second power converter units 70, 72. The EV charging skid 20 can also include a second EV charger 32 affixed or connected to the skid base separately from the third and fourth power converter units 74, 76, where the second EV charger 32 is in electrical communication with one or both of the third and fourth power converter units 74, 76. Each power converter unit 70, 72, 74, 76 supplies DC to an EV charger 30, 32.

In a particular exemplary aspect of the present disclosure, the EV chargers described herein can be EXPP-PL202X1BC-6A1S1-6A1S1-FHWA Express Plus Power Link PL2000 series EV chargers available from ChargePoint, Inc. of Campbell, California. In other aspects of the present disclosure, any suitable EV chargers can be used.

Each EV charger 30, 32 can include one, two, or more charging points. Each charging point can supply any suitable charge. Each EV charger 30 can include two charging points each supplying 150 kW.

In alternative aspects of the present disclosure, one or more of the power converter units and an EV charger can be combined into a single unit that receives AC from the panel cabinet 60, converts the AC to DC, and supplies DC through its charging points. Such a combination unit is more generally used at lower power levels.

The EV charging skid 20 can further include a cable raceway 80 affixed or connected to the skid base 40 where the cable raceway 80 connects the power cabinet 50 to the panel cabinet 60 and the panel cabinet 60 to the first, second, third, and fourth power converter units 70, 72, 74, 76. The raceway can also connect the first, second, third, and fourth power converter units 70, 72, 74, 76 to their respective EV chargers 30, 32. The cable raceway 80 can be of solid manufacture or can be manufactured as raceway portions that are then assembled on the skid base 40.

The cable raceway 80 is configured to accommodate wiring between the EV chargers 30, 32, the power cabinet 50, the panel cabinet 60, the first, second, third, and fourth power converter units 70, 72, 74, 76, any ancillary electrical hardware, and/or an electrical source. Wiring can include any wires, conductors, cables, connectors, and the like needed to make electrical, communications, control, or other connections in the modular EV charging system 10. The cable raceway 80 limits environmental exposure of the cables and wiring as well as unauthorized or inadvertent access to the cables and wiring.

In an alternative aspect of the present disclosure (not shown), the skid base 40 can include internal conduits and/or raceways instead of or in addition to the cable raceway 80.

The EV charging skid 20 can also include attached to the skid base 40 or any of the other components any needed ancillary electrical hardware selected from disconnects, panels, connectors, power supply lines, inverters, converters, regulators, controllers, power modules, power blocks, transformers, or any other suitable hardware. The EV charging skid 20 can include any other electrical hardware needed to control and supply the appropriate AC or DC voltage and current required by the EV chargers 30, 32.

The modular EV charging system 10 can include a power supply line (not shown) to be an electrical source to supply power to the EV charging skid 20. A power supply line can be buried beneath grade and emerge at an aperture 48 of the skid base 40 or can arrive at and be connected to the EV charging skid 20 in any suitable manner.

The EV chargers 30, 32, the power cabinet 50, the panel cabinet 60, the first, second, third, and fourth power converter units 70, 72, 74, 76, the cable raceway 80, and any ancillary electrical hardware can be affixed or connected to the skid base 40 by any suitable means including fasteners such as bolts, nuts, screws, and the like and any other suitable means including welds or adhesives. The EV chargers 30, 32, the power cabinet 50, the panel cabinet 60, the first, second, third, and fourth power converter units 70, 72, 74, 76, the cable raceway 80, and any ancillary electrical hardware can be affixed directly to the skid base 40 or can be connected to the skid base 40 via an intervening structure such as a charger base or pedestal.

The EV chargers 30, 32, the power cabinet 50, the panel cabinet 60, the first, second, third, and fourth power converter units 70, 72, 74, 76, the cable raceway 80, any ancillary electrical hardware, and any bases or pedestals are sized or include apertures sized and positioned to accommodate the power, communication, and control wiring needed to connect the various components. The components of the EV charging skid 20 can be customized to accommodate specific EV charger models by sizing and positioning the components to match those required by the EV charger. In this manner the same skid base 40 can be used with any EV charger.

This configuration allows for the use of different EV charger models with the same skid base 40. In an analogous manner, the skid base 40 can be configured to allow EV chargers to be attached to the skid base 40 in any azimuthal orientation, where the azimuthal orientation is the position of the EV charger relative to the skid base 40 as the EV charger rotates in a horizontal plane about an imaginary vertical central axis.

The EV charging skid 20 can be configured to accommodate any number of EV chargers 30, where each EV charger 30, 32 might or might not require its own additional electrical hardware. In alternative aspects of the present disclosure, the EV charging skid 20 can be configured to accommodate one, two, three, four, or more EV chargers (not shown). Each EV charger can include one or more charging points, and each EV charger can be identical to or a model different from one or more of the other EV chargers. If the modular EV charging system 10 includes three or more EV chargers, the EV chargers can be disposed in a linear array, a square array, or in any other suitable arrangement. The modular EV charging system 10 of the present disclosure flexibly accommodates any number of EV chargers of any identical or differing model and in any azimuthal orientations.

The EV charging skid 20 of the present disclosure can also include protective bollards (not shown) attached to the skid base 40 for the protection of any components associated with the EV charging skid 20.

In an alternative aspect of the present disclosure, the modular EV charging system 10 of the present disclosure can further include an extension skid 120 as illustrated in FIG. 3. The extension skid 120 includes as primary components a skid base 140, an extension EV charger 130, an extension power converter unit 170, an extension cable raceway 180, and any needed ancillary electrical hardware (not shown).

The skid base 140 of the extension skid 120 is a generally slab-like structure constructed in much the same manner as the skid base 40 described above. The skid base 140 includes a top 144 and slab sides 146. The skid base 140 can optionally include channels, lift rings, or other rigging hardware (not shown) to allow the extension skid 120 to be moved by forklift, telehandler, crane, or other suitable device.

Any slab side 146 can be provided with a portion of any suitable interlock system (not shown) useful to affix or connect the skid base 140 to the skid base 40 for stability. The interlock system can be, for example, a key and keyway, a mortise and tenon, a French cleat, dowels and bolts, bow tie fasteners, staples, U-bolts, cable and anchors, and variations and combinations thereof. Portions of the interlock system can be vertical, horizontal, or angled as appropriate.

The extension skid 120 further includes a first extension power converter unit 170 affixed or connected to the skid base 140. The first extension power converter unit 170 is in electrical communication with the panel cabinet 60. The extension skid 120 can also include a second extension power converter unit 172 affixed or connected to the skid base 140 separately and spaced apart from the first extension power converter unit 170, where the second extension power converter unit 172 is in electrical communication with the panel cabinet 60.

The extension skid 120 also includes an extension EV charger 130 affixed or connected to the skid base 140 separately from and spaced apart from the first and second extension power converter units 170, 172. The extension EV charger 130 is in electrical communication with one or both of the first and second extension power converter units 170, 172. Each extension power converter unit 170, 172 supplies direct current (DC) to the extension EV charger 130.

In alternative aspects of the present disclosure, one or more of the power converter units and an EV charger can be combined into a single unit that receives AC from the panel cabinet 60, converts the AC to DC, and supplies DC through its charging points. Such a combination unit is more generally used at lower power levels.

In use the extension skid 120 is positioned adjacent the EV charging skid 20 (shown in phantom in FIG. 3) when additional EV charging points are desired. The extension cable raceway 180 is configured to connect to the cable raceway 80 with an optional connection raceway 82 if needed (see FIG. 2). In this manner the extension skid 120 can receive energy from the panel cabinet 60 and does not require a power cabinet or a panel cabinet of its own, provided the power cabinet 50 and the panel cabinet 60 are configured to provide sufficient power to both the EV charging skid 20 and the extension skid 120. It should be noted that, although shown in one configuration in FIG. 3, the extension skid 120 can be configured to connect to the opposite end of the EV charging skid 20.

To facilitate electrical communication between the EV charging skid 20 and the extension skid 120, conductors from each can be provided with any suitable quick connectors. Quick connectors allow the components of the extension skid 120 to be placed into electrical communication with the components of the EV charging skid 20 with minimal worker time and effort, thereby increasing efficiency and worker safety.

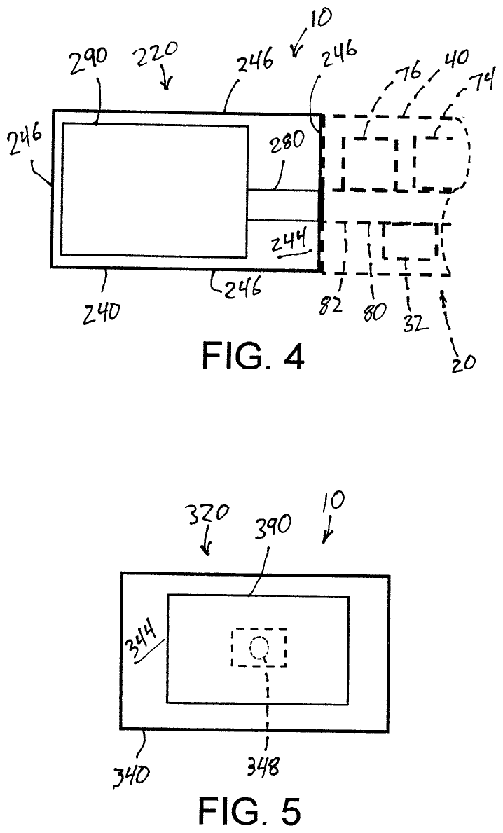

In a further aspect of the present disclosure, the modular EV charging system 10 of the present disclosure can include an extension battery energy storage system (BESS) skid 220 as illustrated in FIG. 4. The extension BESS skid 220 includes as primary components a skid base 240, a BESS 290, an extension cable raceway 280, and any needed ancillary electrical hardware (not shown).

The skid base 240 of the extension BESS skid 220 is a generally slab-like structure constructed in much the same manner as the skid base 40 described above. The skid base 240 includes a top 244 and slab sides 246. The skid base 240 can optionally include channels, lift rings, or other rigging hardware (not shown) to allow the extension BESS skid 220 to be moved by forklift, telehandler, crane, or other suitable device.

Any slab side 246 can be provided with a portion of any suitable interlock system (not shown) useful to affix or connect the skid base 240 to the skid base 40 for stability. The interlock system can be, for example, a key and keyway, a mortise and tenon, a French cleat, dowels and bolts, bow tie fasteners, staples, U-bolts, cable and anchors, and variations and combinations thereof. Portions of the interlock system can be vertical, horizontal, or angled as appropriate.

The BESS 290 can be any suitable energy storage system employing one or more batteries and their associated hardware and connectors. A BESS is typically used to shift load from a period when an energy source is more expensive or less available. A BESS can also be used to supplement energy available from another energy source.

In use the extension BESS skid 220 is positioned adjacent the EV charging skid 20 (shown in phantom in FIG. 4) when energy storage is desired. The extension cable raceway 280 is configured to connect to the cable raceway 80 with an optional connection raceway 82 if needed (see FIG. 2). In this manner the extension BESS skid 220 can receive energy from the panel cabinet 60. It should be noted that, although shown in one configuration in FIG. 4, the extension BESS skid 220 can be configured to connect to the opposite end of the EV charging skid 20.

To facilitate electrical communication between the EV charging skid 20 and the extension BESS skid 220, conductors from each can be provided with any suitable quick connectors. Quick connectors allow the components of the extension BESS skid 220 to be placed into electrical communication with the components of the EV charging skid 20 with minimal worker time and effort, thereby increasing efficiency and worker safety.

In a still further aspect of the present disclosure, the modular EV charging system 10 of the present disclosure can include a remote BESS skid 320 as illustrated in FIG. 5. The remote BESS skid 320 includes as primary components a skid base 340, a BESS 390, an aperture 348 through the skid base 340, and any needed ancillary electrical hardware (not shown).

The skid base 340 of the remote BESS skid 320 is a generally slab-like structure constructed in much the same manner as the skid base 40 described above. The skid base 340 includes a top 344. The skid base 340 can optionally include channels, lift rings, or other rigging hardware (not shown) to allow the remote BESS skid 320 to be moved by forklift, telehandler, crane, or other suitable device.

The BESS 390 can be any suitable energy storage system employing one or more batteries and their associated hardware and connectors. A BESS is typically used to shift load from a period when an energy source is more expensive or less available. A BESS can also be used to supplement energy available from another energy source.

In use the remote BESS skid 320 is positioned in the vicinity of the EV charging skid 20 when energy storage is desired. Underground conduit or other suitable connection means (not shown) is configured to connect the panel cabinet 60 through its aperture 48 through the aperture 348 of the skid base 340 to the BESS 390. In this manner the remote BESS skid 320 can receive energy from the panel cabinet 60.

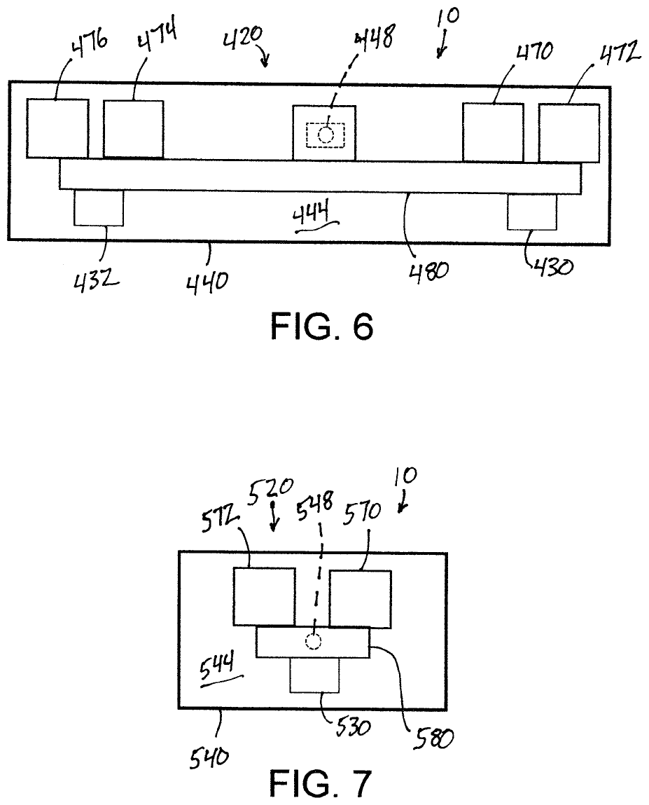

In another alternative aspect of the present disclosure, the modular EV charging system 10 of the present disclosure can further include a remote EV charging skid 420, as illustrated in FIG. 6. The remote EV charging skid 420 includes as primary components a skid base 440, a remote skid EV charger 430, a remote skid power converter unit 470, a remote skid cable raceway 480, and any needed ancillary electrical hardware (not shown).

The skid base 440 of the remote EV charging skid 420 is a generally slab-like structure constructed in much the same manner as the skid base 40 described above. The skid base 440 includes a top 444. The skid base 440 can optionally include channels, lift rings, or other rigging hardware (not shown) to allow the remote EV charging skid 420 to be moved by forklift, telehandler, crane, or other suitable device.

The remote EV charging skid 420 further includes a first remote skid power converter unit 470 affixed or connected to the skid base 440. The first remote skid power converter unit 470 is in electrical communication with the panel cabinet 60. The remote EV charging skid 420 can also include a second remote skid power converter unit 472 affixed or connected to the skid base 440 separately and spaced apart from the first remote skid power converter unit 470, where the second remote skid power converter unit 472 is in electrical communication with the panel cabinet 60.

The remote EV charging skid 420 can also include third and fourth remote skid power converter units 474, 476 affixed or connected to the skid base 440 separately from each other and separately from the first and second remote skid power converter units 470, 472. The third and fourth remote skid power converter units 474, 476 are each in electrical communication with the panel cabinet 60. The panel cabinet 60 supplies AC to each remote skid power converter unit 470, 472, 474, 476. Each remote skid power converter unit 470, 472, 474, 476 converts AC to DC.

The remote EV charging skid 420 also includes a remote skid EV charger 430 affixed or connected to the skid base 440 separately from and spaced apart from the first and second remote skid power converter units 470, 472. The remote skid EV charger 430 is in electrical communication with one or both of the first and second remote skid power converter units 470, 472. Each remote skid power converter unit 470, 472 supplies DC to the remote skid EV charger 430.

The remote EV charging skid 420 can also include a second remote skid EV charger 432 affixed or connected to the skid base 440 separately from the third and fourth remote skid power converter units 474, 476, where the second remote skid EV charger 432 is in electrical communication with one or both of the third and fourth remote skid power converter units 474, 476. Each remote skid power converter unit 470, 472, 474, 476 supplies DC to an EV charger 430, 432.

In alternative aspects of the present disclosure, one or more of the power converter units and an EV charger can be combined into a single unit that receives AC from the panel cabinet 60, converts the AC to DC, and supplies DC through its charging points. Such a combination unit is more generally used at lower power levels.

In use the remote EV charging skid 420 is positioned in the vicinity of the EV charging skid 20 when additional EV charging points are desired. Underground conduit or other suitable connection means (not shown) is configured to connect the panel cabinet 60 through its aperture 48 through the aperture 448 of the skid base 440 to the remote skid cable raceway 480. In this manner the remote EV charging skid 420 can receive energy from the panel cabinet 60 and does not require a power cabinet or a panel cabinet of its own, provided the power cabinet 50 and the panel cabinet 60 are configured to provide sufficient power to both the EV charging skid 20 and the remote EV charging skid 420.

In still another alternative aspect of the present disclosure, the modular EV charging system 10 of the present disclosure can further include a supplemental EV charging skid 520, as illustrated in FIG. 7. The supplemental EV charging skid 520 includes as primary components a skid base 540, a supplemental skid EV charger 530, a supplemental skid power converter unit 570, a supplemental skid cable raceway 580, and any needed ancillary electrical hardware (not shown).

The skid base 540 of the supplemental EV charging skid 520 is a generally slab-like structure constructed in much the same manner as the skid base 40 described above. The skid base 540 includes a top 544. The skid base 540 can optionally include channels, lift rings, or other rigging hardware (not shown) to allow the supplemental EV charging skid 520 to be moved by forklift, telehandler, crane, or other suitable device.

The supplemental EV charging skid 520 further includes a first supplemental skid power converter unit 570 affixed or connected to the skid base 540. The first supplemental skid power converter unit 570 is in electrical communication with the panel cabinet 60. The supplemental EV charging skid 520 can also include a second supplemental skid power converter unit 572 affixed or connected to the skid base 540 separately and spaced apart from the first supplemental skid power converter unit 570, where the second supplemental skid power converter unit 572 is in electrical communication with the panel cabinet 60. Each supplemental skid power converter unit 570, 572 converts AC to DC.

The supplemental EV charging skid 520 also includes a supplemental skid EV charger 530 affixed or connected to the skid base 540 separately from and spaced apart from the first and second supplemental skid power converter units 570, 572. The supplemental skid EV charger 530 is in electrical communication with one or both of the first and second supplemental skid power converter units 570, 572. Each supplemental skid power converter unit 570, 572 supplies DC to the supplemental skid EV charger 530.

In alternative aspects of the present disclosure, one or more of the power converter units and an EV charger can be combined into a single unit that receives AC from the panel cabinet 60, converts the AC to DC, and supplies DC through its charging points. Such a combination unit is more generally used at lower power levels.

In use the supplemental EV charging skid 520 is positioned in the vicinity of the EV charging skid 20 when additional EV charging points are desired. Underground conduit or other suitable connection means (not shown) is configured to connect the panel cabinet 60 through its aperture 48 through the aperture 548 of the skid base 540 to the supplemental skid cable raceway 580. In this manner the supplemental EV charging skid 520 can receive energy from the panel cabinet 60 and does not require a power cabinet or a panel cabinet of its own, provided the power cabinet 50 and the panel cabinet 60 are configured to provide sufficient power to both the EV charging skid 20 and the supplemental EV charging skid 520.

The flexibility of this modular EV charging system 10 allows for various levels of offsite versus onsite construction. The primary components of the modular EV charging system 10 are EV chargers 30, 32, the power cabinet 50, the panel cabinet 60, the first, second, third, and fourth power converter units 70, 72, 74, 76, the cable raceway 80, any ancillary electrical hardware and are preferably constructed, acquired, and/or combined offsite. In one aspect of the present disclosure, the EV chargers 30 and the other components are attached to the skid base 40 to make an EV charging skid 20 offsite and then shipped to a site as a complete unit ready for installation. If the skid base 40 includes an aperture 48, the EV charging skid 20 can be placed at the site such that the aperture 48 aligns with the electrical source. The extension, remote, and supplemental skids can be constructed, shipped, and sited in a similar manner.

In an alternative aspect of the present disclosure, these components can be shipped to a site and assembled into an EV charging skid 20 onsite by attaching the EV chargers 30 and other components to the skid base 40.

While the disclosure has been described in detail with respect to specific aspects thereof, it will be appreciated that those skilled in the art, upon attaining understanding of the foregoing will readily appreciate alterations to, variations of, and equivalents to these aspects. Accordingly, the scope of the present disclosure should be assessed as that of the appended claims and any equivalents thereto. Additionally, all combinations and/or sub-combinations of the disclosed aspects, ranges, examples, and alternatives are also contemplated.

1. An electric vehicle (EV) charging skid including at least one EV charger, the EV charging skid comprising:
a pre-cast concrete skid base having an aperture formed therethrough;
a power cabinet having a bottom surface with a cabinet bottom opening, wherein the power cabinet is connected to the skid base such that the power cabinet covers the aperture and the aperture is accessible through the cabinet bottom opening, and wherein the power cabinet is configured to receive electricity from an electrical source via the aperture and cabinet bottom opening;
a panel cabinet connected to the skid base, wherein the panel cabinet is in electrical communication with the power cabinet;
a first power converter unit connected to the skid base, wherein the first power converter unit is in electrical communication with the panel cabinet; and
an EV charger connected to the skid base separately from the first power converter unit, wherein the EV charger is in electrical communication with the first power converter unit.

2. The EV charging skid of claim 1, further comprising a cable raceway connected to the pre-cast concrete skid base and connecting the panel cabinet to the first power converter unit.

3. The EV charging skid of claim 2, the cable raceway further connecting the first power converter unit to the EV charger.

4. The EV charging skid of claim 1, further comprising a second power converter unit connected to the pre-cast concrete skid base separately from the first power converter unit, wherein the second power converter unit is in electrical communication with the panel cabinet and the EV charger.

5. The EV charging skid of claim 1, wherein the power cabinet includes utility-facing switchgear in electrical communication with the electrical source.

6. The EV charging skid of claim 1, wherein the panel cabinet includes distribution switchgear in electrical communication with the first power converter unit.

7. The EV charging skid of claim 1, wherein the first power converter unit converts alternating current to direct current.

8. The EV charging skid of claim 1, wherein the panel cabinet is configured to supply alternating current to the first power converter unit and the first power converter unit is configured to supply direct current to the EV charger.

9. The EV charging skid of claim 1, the EV charger further comprising two charging points.

10. The EV charging skid of claim 9, wherein each charging point is configured to supply at least 150 kW.

11. A modular electric vehicle (EV) charging system having at least two EV chargers, the modular EV charging system comprising a foundational EV charging skid including:
a pre-cast concrete skid base having an aperture formed therethrough, the pre-cast concrete skid base including transport channels;
a panel cabinet having a bottom surface with a cabinet bottom opening, wherein the panel cabinet is connected to the pre-cast concrete skid base such that the panel cabinet covers the aperture and the aperture is accessible through the cabinet bottom opening, and wherein the panel cabinet is configured to receive electricity from an electrical source via the aperture and cabinet bottom opening;
a first power converter unit connected to the pre-cast concrete skid base, wherein the first power converter unit is in electrical communication with the panel cabinet;
a second power converter unit connected to the pre-cast concrete skid base separately from the first power converter unit, wherein the second power converter unit is in electrical communication with the panel cabinet;
a first EV charger connected to the pre-cast concrete skid base separately from the first and second power converter units, wherein the first EV charger is in electrical communication with the first and second power converter units;
third and fourth power converter units connected to the pre-cast concrete skid base separately from each other and from the first and second power converter units, wherein the third and fourth converter units are in electrical communication with the panel cabinet;
a second EV charger connected to the pre-cast concrete skid base separately from the third and fourth power converter units, wherein the second EV charger is in electrical communication with the third and fourth power converter units; and
a cable raceway connected to the pre-cast concrete skid base and connecting the panel cabinet to the first, second, third, and fourth power converter units, the first and second converter units to the first EV charger, and the third and fourth power converter units to the second EV charger.

12. The modular electric vehicle (EV) charging system of claim 11, further comprising a secondary EV charging skid including
a secondary EV charging skid base, and
a third EV charger connected to the secondary EV charging skid base, wherein the third EV charger is in electrical communication with the foundational EV charging skid.

13. The modular electric vehicle (EV) charging system of claim 12, wherein secondary EV charging skid includes a power converter unit.

14. The modular electric vehicle (EV) charging system of claim 12, wherein the pre-cast concrete skid base is connected to the secondary EV charging skid base using an interlock system.

15. The modular electric vehicle (EV) charging system of claim 12, wherein the third EV charger is in electrical communication with the panel cabinet via an underground conduit.

16. The modular electric vehicle (EV) charging system of claim 11, further comprising a battery energy storage system (BESS) skid including
a BESS skid base, and
a BESS connected to the BESS skid base, wherein the BESS is in electrical communication with the foundational EV charging skid.

17. The modular electric vehicle (EV) charging system of claim 16, wherein the BESS is in electrical communication with the panel cabinet via a cable raceway connected to the pre-cast concrete skid base and the BESS skid base.

18. The modular electric vehicle (EV) charging system of claim 16, wherein the BESS is in electrical communication with the panel cabinet via an underground conduit.

19. A method for providing at a site an electric vehicle (EV) charging system including an EV charging skid, the method comprising:
procuring a pre-cast concrete skid base having an aperture formed therethrough;
affixing to the pre-cast concrete skid base a panel cabinet having a bottom surface with a cabinet bottom opening such that the panel cabinet covers the aperture and the aperture is accessible through the cabinet bottom opening, wherein the panel cabinet is configured to receive electricity from an electrical source via the aperture and cabinet bottom opening;
affixing a first power converter unit to the pre-cast concrete skid base, wherein the first power converter unit is in electrical communication with the panel cabinet;
affixing an EV charger to the pre-cast concrete skid base separately from the first power converter unit, wherein the EV charger is in electrical communication with the first power converter unit; and then
delivering the EV charging skid to the site.

20. The method of claim 19, further comprising placing the EV charging skid such that the aperture aligns with the electrical source.
